(19) United States
(12) Patent Application Publication
(10) Pub. No.: US 2016/0206978 A1
(43) Pub. Date: Jul. 21, 2016

(54) Sand Screen Filter with Non-Uniform Pores

(71) Applicant: Dorstener Wire Tech, Spring, TX (US)

(72) Inventors: Rick T. Kenney, Longwood, FL (US); Ruediger Tueshaus, Dorsten (DE); Patrick W. McGrenera, The Woodlands, TX (US)

(21) Appl. No.: 14/597,337

(22) Filed: Jan. 15, 2015

(51) Int. Cl. B01D 29/13

(52) U.S. Cl. CPC B01D 29/13

(57) ABSTRACT

A sand screen filter for an oil or gas well includes a support frame and a cylindrical woven wire mesh attached to the support frame. The woven wire mesh has a randomly varying pore size and or shape which creates fluid flow passages of varying sizes for the produced fluid. The sand screen filter may include an apertured protective shroud and may be attached to a perforated tubular. The woven wire mesh element may be used in any filter that includes a woven wire mesh element.

### BACKGROUND OF INVENTION

1. Field of the Invention

This invention which is the subject matter of this patent application is directed to a filter element of the woven wire mesh type which is used in filters which may include a sand screen filter used in the production of fluids from an oil or gas well. Sand screen filters are positioned over perforated production tubulars to filter out solid particles prior to the fluid entering the production tubing.

2. Description of Related Art

Sand screen filters using woven wire mesh filter elements are well known in the art. One or layers of woven wire mesh of varying pore size are placed over a portion of the production tubing having apertures for the produced well fluids. A support structure is provided for supporting the wire mesh layer(s) and usually a guard is positioned above the assembly for protecting the woven wire mesh.

The woven wire mesh used for the filter screens is standard woven wire mesh of uniform pore size. According to the particular weave pattern, the pore shapes can be square, rectangular or other geometric shapes but in any event the pores are formed by longitudinal and transverse wires so as to define uniform size and shape over the entire extent of the mesh.

### BRIEF SUMMARY OF THE INVENTION

The present invention is to form a woven wire mesh with non-uniform pore sizes and or shapes over a substantial portion of its area. The so formed woven wire mesh serves as the filter element for a sand screen filter. This creates a multitude of pores of varying sizes and shapes in the filter with the result that not all of the pores will become clogged during use. The presence of varying size and shape pores will accommodate varying conditions within the formation. As a sand screen filter is used in an oil/gas well environment, a layer known as “caking” forms around the filter. It is composed of sand or other particulate material of varying sizes. It has been found that filter layers comprised of woven wire mesh having uniform pores will clog much quicker in certain sand formations than woven wire mesh having varying pore sizes and shapes. While some clogging occurs it has been discovered that the caking formed outside the filter layer forms in such a way that alternate flow passages are formed through the caking A more permeable filter cake with varied pore geometries builds around the filter screen ensuring that multiple, alternate flow paths form through the cake. In addition, it has been found that backwashing of the filter element is considerably easier due to the irregular sizes and shapes of the pores. The invention can be applied to any of the well-known weave patterns for woven wire mesh including, for example, square, twill, plan Dutch and Dutch twill or combinations of these. The invention is useful also in any filter that includes a woven wire mesh filter element.

### BRIEF DESCRIPTION OF THE SEVERAL VIEWS OF THE DRAWING(S)

FIG. 1 is a cross-sectional view of a sand screen filter according to an embodiment of the invention.

FIG. 2 is a perspective view of a sand screen filter according to an embodiment of the invention.

FIG. 3 is a top view of a first embodiment of a woven wire mesh filter element according to the invention.

FIG. 4 is a top view of a second embodiment of a woven wire mesh filter element according to the invention.

FIG. 5 is a top view of a third embodiment of a woven wire mesh filter element according to the invention.

FIG. 6 is a top view of a forth embodiment of a woven wire mesh filter element according to the invention.

### DETAILED DESCRIPTION OF THE INVENTION

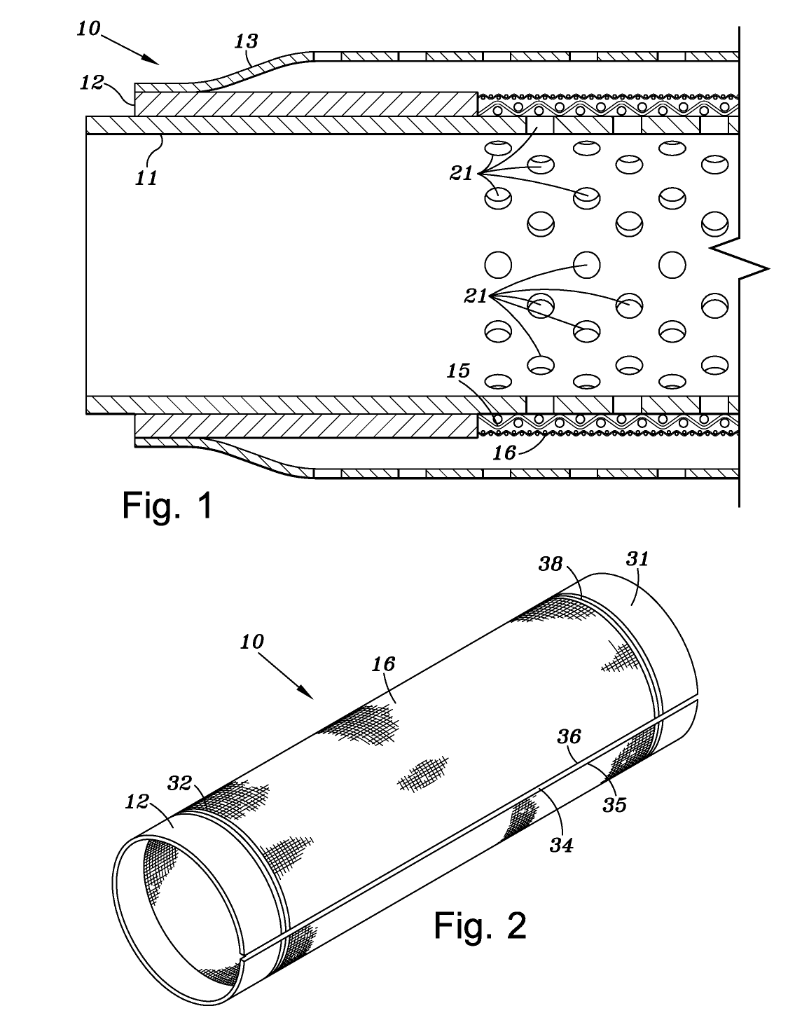

As shown in FIGS. 1 and 2, a sand screen filter according to an embodiment of the invention includes a tubular 11 which may be a production tubular having a plurality of apertures 21 for accommodating flow of production fluid from the formation to the interior of the production tubular.

A first annular, cylindrical filtering sleeve 15 surrounds the production pipe and is secured thereto by an annular collar 12 at 32. A second annular, cylindrical filtering sleeve 16 is optionally positioned around the first annular cylindrical filtering sleeve and may have a pore size equal to, less than or greater than the pore size of first sleeve 15.

A protective shroud 13 having relatively large openings are attached to collar 12 at one end. Outer shroud 13 protects the woven wire mesh and is formed of a relatively rigid sheet material such as stainless steel for example.

As shown in FIG. 2, filtering sleeves 15 and 16 are secured to a second annular collar 31 at 38 which may be by welding. Collars 12 and 31 form a support frame for the screens 15 and 16. Opposing edges of collars 12 and 31 as well as opposing edges 36 and 35 of screens 15 and 16 may be secured together along a longitudinal seam 34 which may be a welded seam.

Alternately the sand screen assembly may be formed in the manner disclosed in U.S. patent application Ser. No. 13/708,124, filed Dec. 7, 2012, the contents of which is expressly incorporated herein by reference thereto.

The number of annular cylindrical filter sleeves can vary from one to several layers. The filters are formed of woven wire mesh having irregularly sized and spaced pores.

Conventional sand screen filters are made with conventional woven metal mesh wherein the pores are formed with a uniform repeating geometry whereas according to the present invention the pores are irregularly shaped and non-repeating.

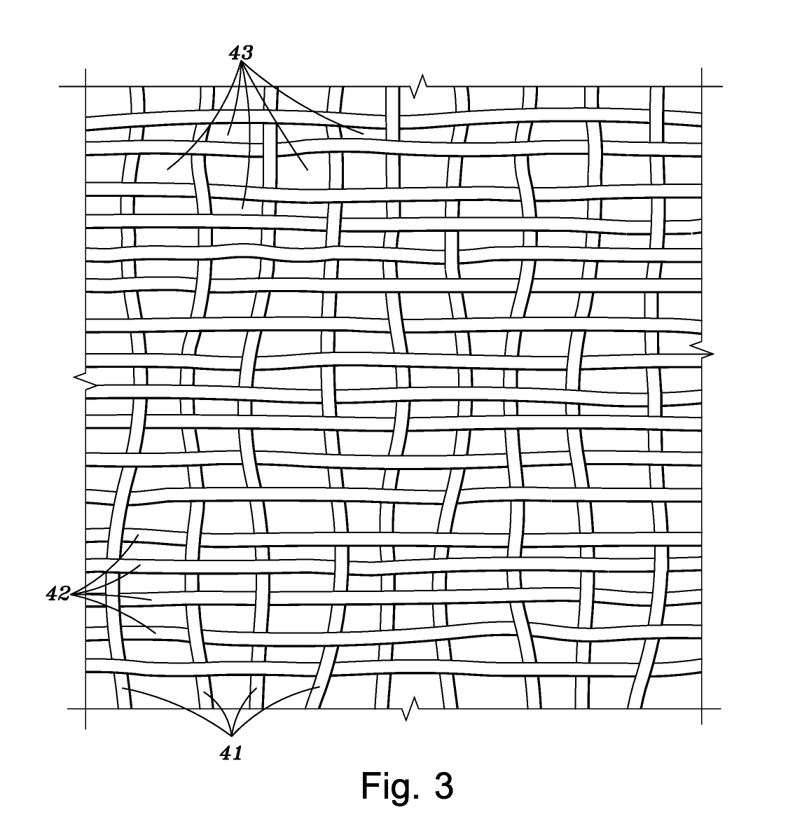

An example of the woven wire mesh used in this invention is shown in FIG. 3. A woven wire mesh is formed by longitudinal wires called warp wires 41 and transverse wires 42 called weft or shute wires. In a conventional woven wire mesh, the warp wires and parallel to each other and so are the weft wires. They can be arranged relative to each other to form pores having square, rectangular, triangular shapes and other geometric shapes.

As can be seen in FIG. 3, the warp wires 41 and weft wires 42 are not parallel to each other but rather are formed such that they are randomly non-linear thus creating a varying distance between each other. This has the effect of forming pores 43 of random size and shape. This effect can be achieved with different layers of weave patters as shown in FIGS. 3-6.

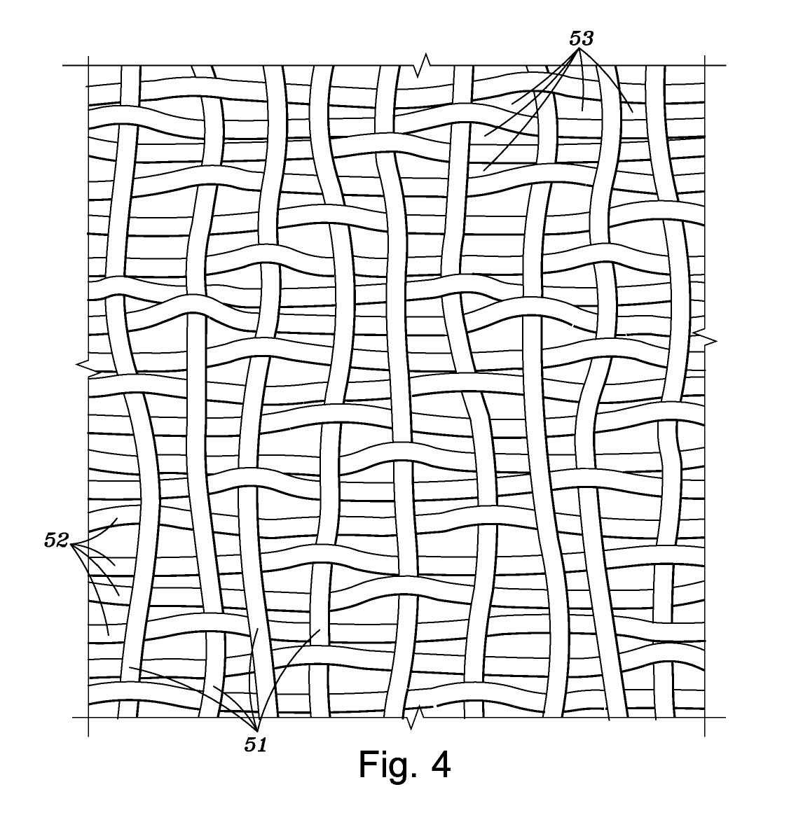

FIGS. 4-6 show various modified twill weave patterns incorporating the invention.

In FIG. 4, the warp wires 51 are randomly curved wires as are the weft wires 52 so the pores 53 are of varying sizes and shape.

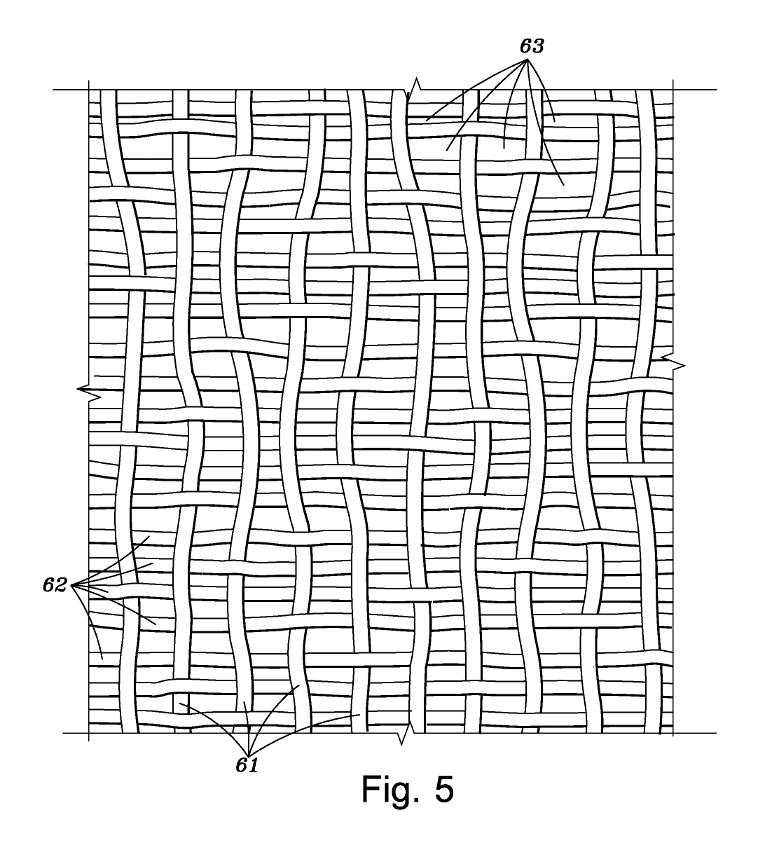

As shown in FIG. 5, warp wires 61 are also randomly curved as are the weft wires 62 which again forms pores 63 of varying sizes.

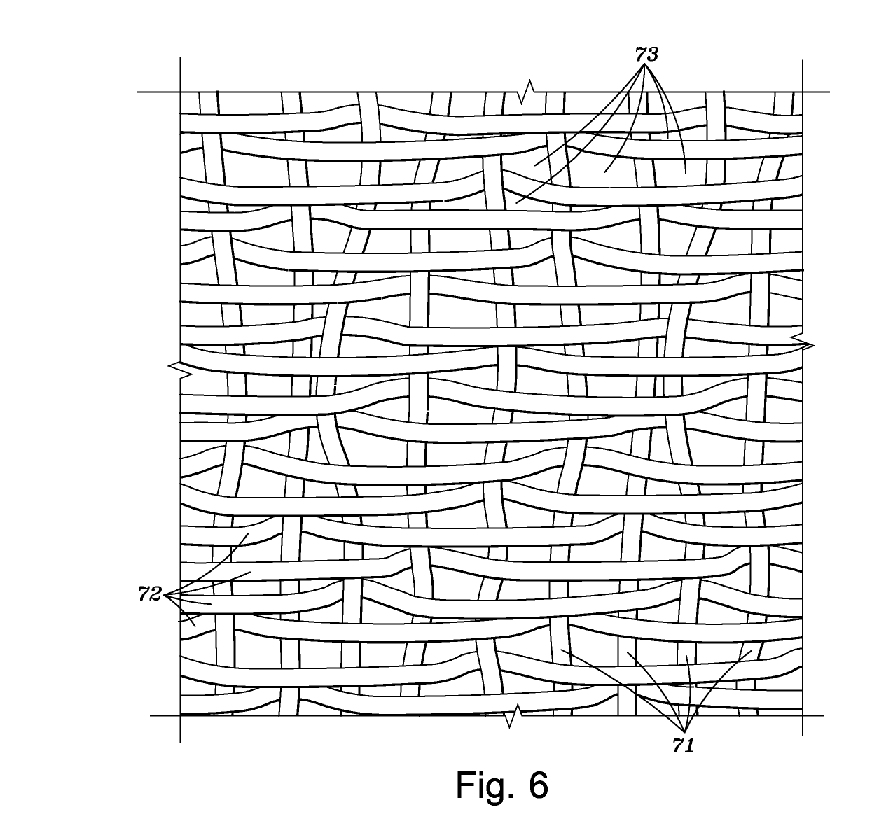

The same is true for the weave pattern shown in FIG. 6, where warp wires 71 and warp wires 72 form irregular pores 73.

In some cases it is only necessary to vary the distance between either the warp wires or weft wires to achieve the non-uniform distribution of pore sizes.

The woven wire mesh sizes suitable for use in the sand screen filter according to the invention may include wire having a diameter between 0.05 mm to 1.00 mm, preferable 0.1 to 0.5 mm. The average pore size can be 50 microns to 5,000 microns, preferable 100 to 600 microns.

Standard Materials micron cloth in the market place (Dutch Weave, Twill Dutch Weave, Reverse Dutch Weave, Revers Twill Dutch Weave and/or 5 Shaft Weave) with a micron rating of approximate 300 where tested. The maximum air permeability for the tested items was 800 Scfm.sf at 1″ water column. The new weave design with the same micron range had a minimum of 60% more flow under the same test conditions.

Although the present invention has been described with respect to specific details, it is not intended that such details should be regarded as limitations on the scope of the invention, except to the extent that they are included in the accompanying claims.

I claim:

1. A sand filter screen comprising:
a support frame;
a woven wire mesh in the form of a cylindrical sleeve attached to the support frame; and
the woven wire mesh having pores that are non-uniform in size and or shape.

2. A sand filter screen as claimed in claim 1 further including an apertured protective shroud surrounding the woven wire mesh.

3. A sand filter screen as claimed in claim 1 wherein the woven wire mesh has warp wires and werf wires, the spacing between either the warp wires or werf wires being randomly varied.

4. A sand filter screen as claimed in claim 1 wherein the wire has a diameter from 0.05 mm to 1.00 mm.

5. A sand filter screen as claimed in claim 4 wherein the average pore size is from 50 microns to 5,000 microns.

6. A sand filter screen as claimed in claim 1 further including a tubular having a plurality of apertures, the support frame and woven wire mesh being attached to the tubular.

7. A woven wire mesh filter element comprising:
a wire mesh filter screen having a plurality of pores; and
said pores being non-uniform in size and shape.

8. A woven wire mesh filter element as claimed in claim 7 wherein the screen has warp wires and werf wires, the spacing between either the warp wires or werf wires being randomly varied.

9. A woven wire mesh filter element as claimed in claim 7 wherein the average pore size of the screen is from 50 microns to 5,000 microns.
